(19) United States
(12) Patent Application Publication
(10) Pub. No.: US 2026/0057676 A1
(43) Pub. Date: Feb. 26, 2026

(54) HARDWARE MULTI-FUNCTIONAL SMART CAMERA SYSTEM CONTROLLED BY CLOUD-BASED SYSTEM

(71) Applicant: Save My Play, LLC, New York, NY (US)

(72) Inventors: David Fox, New York, NY (US); Martin Fox, Setauket, NY (US)

(21) Appl. No.: 19/310,174

(22) Filed: Aug. 26, 2025

Related U.S. Application Data
(60) Provisional application No. 63/687,074, filed on Aug. 26, 2024.
(60) Provisional application No. 63/839,793, filed on Jul. 7, 2025.

(51) Int. Cl. G06V 20/52; H04N 23/90

(52) U.S. Cl. CPC G06V 20/52; H04N 23/90

(57) ABSTRACT

A system provides video files of a participant participating in an activity at a facility, the system comprising a plurality of smart cameras, each associated with a facility location and including an image sensor, optical elements, processor-executable instructions in first memory, second memory for storing captured video, and network transceiver circuitry; a cloud-based storage server for receiving and storing video content from the smart cameras; and a cloud-based control server that, upon user command to generate a participant video file at a specified location, directs at least one associated smart camera to assemble a video file from stored content and upload the generated file to the cloud-based storage server.

### CROSS-REFERENCE TO RELATED APPLICATION

This application is a non-provisional of, and claims the benefit of, U.S. Provisional Application No. 63/687,074, filed on Aug. 26, 2024, entitled, “HARDWARE MULTI-FUNCTIONAL SMART CAMERA SYSTEM CONTROLLED BY CLOUD-BASED SYSTEM,” and U.S. Provisional Application No. 63/839,793, filed on Jul. 7, 2025, entitled, “HARDWARE MULTI-FUNCTIONAL SMART CAMERA SYSTEM CONTROLLED BY CLOUD-BASED SYSTEM.” The disclosure of each of the aforementioned applications is hereby incorporated by reference in its entirety.

### BACKGROUND

With the increasing availability of video capture devices and with an increasing demand for video content, many people are interested in being able to record and view video content of themselves and others. Many facilities, for example, sports complexes, performing arts facilities, music studios, educational facilities, etc., may provide a number of video capture devices in different locations within the facility that capture video content at the locations and upload the video content to a cloud server from which it can be provided to various different interested parties. For example, an indoor sports facility (e.g., a tennis court facility) may have a plurality of locations (e.g., tennis courts), each of which having at least one video capture device that captures, and uploads to a cloud storage server, video content throughout the time that the facility is open. A user interface can be provided to the cloud storage server, through which people interested in the content (e.g., players, fans, coaches, friends and relatives, etc.) can find content that they are interested in and then can replay that content.

However, existing systems rely heavily on transmitting all, or large amounts of, the video content to a central server or cloud storage service, requiring significant transmission bandwidth, significant amounts of cloud storage, expensive on-premise servers, etc. Because of this, facilities have faced significant challenges in providing an efficient, low cost, easy-to-use and access solution for providing video content to users and interested parties of the facility.

### SUMMARY

In some aspects, the techniques described herein relate to a system for providing video files of a participant participating in an activity at a facility that includes a plurality of locations. The system includes a plurality of smart cameras, where at least one smart camera is associated with each location of the plurality of locations, where each smart camera includes: an image sensor configured for capturing images of objects in a field of view of the smart camera, one or more optical elements configured for projecting an image of a field of view of the smart camera onto the image sensor, first memory configured for storing machine readable instructions, a processor configured for executing the stored instructions, second memory configured for storing video content captured by the smart camera, and transmission and receiving circuity configured to send and receive data to/from a network to which the smart camera is connected. The system also includes a cloud-based storage server configured for receiving and storing video content from each of the plurality of smart cameras. The system also includes a cloud-based control server configured for receiving a command from a user to generate a video file of a participant participating in an activity at one of the locations of the plurality of locations at the facility, and, causing, in response to the command, at least one of the smart cameras associated with the location to generate a video file from video content captured by the camera and stored in the second memory and to send the generated video file to the cloud-based storage server.

In some aspects, the techniques described herein relate to a method of providing video files of a participant participating in an activity at a facility that includes a plurality of locations. The method includes capturing video content with at least one smart camera associated with a location of the plurality of locations, where the at least one smart camera includes: an image sensor configured for capturing images of objects in a field of view of the smart camera, one or more optical elements configured for projecting an image of a field of view of the smart camera onto the image sensor, first memory configured for storing machine readable instructions, a processor configured for executing the stored instructions, second memory configured for storing video content captured by the smart camera. The method also includes storing video content captured by the smart camera in the second memory. The method also includes receiving, at a cloud-based control server, a command from a user to generate a video file of a participant participating in an activity at the location of the plurality of locations. The method also includes providing instructions from the cloud-based control server to the at least one smart camera for the smart camera to generate a video file from the stored video content captured by the camera and stored in the second memory. The method also includes transmitting the generated video file from the smart camera to a cloud-based storage server for storage the cloud-based storage server.

### BRIEF DESCRIPTION OF DRAWINGS

FIG. 1 is a schematic diagram of a system for providing an efficient, low cost, easy-to-use and access solution for providing video content to users and interested parties of a facility that includes a plurality of smart cameras that each are associated with one or more locations within the facility.

FIG. 2 is a schematic diagram of an example smart camera, which can be used as one of the smart cameras in the system of FIG. 1.

FIG. 3 is a schematic view of an example workflow of a process for saving a snippet of video content from one or more smart cameras to a cloud-based storage device to make the snippet available to a user.

FIG. 4 is an example perspective view of unique identifiers that can be used by a user to gain access to the ability to save and access video content from the smart cameras, where the video content is recorded from a particular location and during a particular time interval.

FIG. 5A is a screenshot of an example user interface executing on a mobile computing device.

FIG. 5B is a screenshot of an example user interface executing on a wearable computing device.

FIG. 6 is a screenshot of an example user interface of a web service executing on a mobile computing device.

FIG. 7 illustrates an example architecture of a computing device that can be used to implement aspects of the present disclosure.

### DETAILED DESCRIPTION

This document describes examples of systems and techniques for providing an efficient, low cost, easy-to-use and access solution for providing video content to users and interested parties of a facility. Systems and techniques described herein make use of smart edge devices that are connected to a cloud-based control server. These smart edge devices can capture video content from different locations within the facility and can transmit the captured video content to a cloud-based storage server from which the content can be accessed by users of the system. Rather than constantly transmitting video content to the cloud-based storage server while the edge devices are in use or transmitting all of the video content to the cloud-based storage server, the smart edge devices can capture video content, locally store the content, receive control signals from the cloud-based control server to transmit particular requested small snippets of the captured video content, and respond to the control signals by uploading the requested small snippets to the cloud-based storage server. When video content is not specifically requested from a smart edge device, the smart edge devices do not upload or offload video footage to the cloud, but they continue to record video content and save it locally in their own memory storage devices (e.g., on a micro SD card), so that the stored video content can be uploaded if requested.

The small snippets of the captured video that are uploaded to the cloud-based storage server may be uploaded at the request of a user of the system, who may be interested in viewing only the small snippets of the video content, rather than a large portion of the entire video content that is captured. Once the small snippets are uploaded to the cloud-based storage server, they can be made available to the user who requested them for viewing, reviewing, and sharing.

By uploading small snippets of the captured video content, which are specifically requested, instead of uploading a continuous stream of captured video content, the bandwidth load on the communication channel between the smart edge devices and the cloud-based storage server can be significantly reduced. Furthermore, the transmission of the requested small snippets can be provided through an asynchronous communication protocol that ensures a reliable transfer of the video content, even over a low bandwidth communication channel.

In addition, the user who requests the short snippet is spared from having to scan through a long video file to find the particular snippet of video content that the user is interested in.

The smart edge devices can include a video capture system, a memory device, a processor, and a data transmission module. The video capture system can include components of a camera, such as, for example, one or more lenses for imaging objects in a field of view of the video capture device and an image sensor (e.g., a charge coupled device (CCD) or an active pixel sensor, such as, for example, a complimentary metal-oxide semiconductor (CMOS) sensor), for capturing images of the objects (e.g., frames of video content). The memory can store captured video content, for example, many hours of captured video content. The data transmission module can include circuitry to receive instructions from a cloud-based control server and to transmit video snippets to a cloud-based storage server. The processor can execute instructions stored in memory to process instructions received from the cloud-based storage server and to control the edge device to respond to the instructions, for example, by uploading a requested snippet, by changing the field of view of the video capture system, and by performing a variety of other actions, as described herein. The system does not need to include a local hub or local server in the facility to transmit video content from the smart edge devices (also referred to herein as smart cameras or simply as cameras) to the cloud-based storage server but rather can transmit the video content directly from the edge device to the cloud-based storage server, for example, by transmitting the video content to an Internet-connected modem that transmits the video content over the Internet to the cloud-based storage server. In some implementations, the smart edge devices can transmit video content captured by, and stored on, the edge devices over a wireless link to the cloud-based storage server, and the smart edge devices can transmit the content directly to a modem or to a router that is connected to a modem for transmission to the cloud-based storage server, without going through an intermediate local server or hub.

To interact with the system, a user does not need to connect directly to the camera, but instead the user can connect to a web service, through which the user can instruct the cloud-based control server to control and instruct the camera devices on the user's behalf.

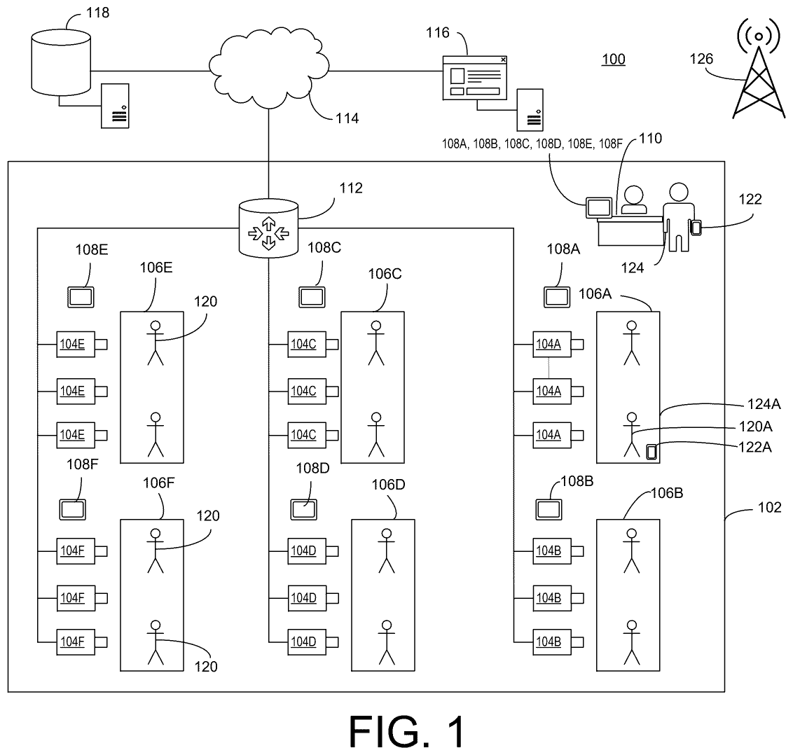

FIG. 1 is a schematic diagram of a system 100 for providing an efficient, low cost, easy-to-use and access solution for providing video content to users and interested parties of a facility 102 that includes a plurality of smart cameras 104A, 104B, 104C, 104D, 104E, 104F that each are associated with one or more locations 106A, 106B, 106C, 106D, 106E, 106F within the facility. The facility can be an indoor facility or an outdoor facility. Some examples of an indoor or outdoor tennis or pickleball center having multiple courts as locations, an indoor or outdoor ice rink complex having multiple rinks as locations, an indoor gymnasium having multiple basketball courts and/or volleyball courts and/or pitching machines as locations, an outdoor park having multiple basketball or volleyball courts or baseball fields as locations, a golf course or driving range having multiple holes and/or tee stations as locations, a performing arts facility having one or more performance spaces or practice studios/room as locations, a physical therapy or medical practice having multiple examination and/or exercise locations, etc.

The facility 102 can include a large number of distinct locations 106A, 106B, 106C, 106D, 106E, 106F (e.g., 3 or more locations, 10 or more locations, 30 or more locations, or 100 or more locations) and a large number of smart cameras 104A, 104B, 104C, 104D, 104E, 104F (e.g., 10 or more, 30 or more smart cameras, 100 or more smart cameras, or 300 or more smart cameras). Each smart camera 104A, 104B, 104C, 104D, 104E, 104F that is associated with a particular location 106A, 106B, 106C, 106D, 106E, 106F can record video content in its field of view and store the recorded content locally on one or more memory storage devices located on the smart camera. In some implementations, a plurality of smart cameras can be associated with the particular location 106A, 106B, 106C, 106D, 106E, 106F. For example, as shown in FIG. 1, three cameras can be associated with each location 106A, 106B, 106C, 106D, 106E, 106F, and in some implementations, more than five, more than 10, more than 20, cameras can be associated with each location to provide different fields of view of the different locations.

The video content stored locally on the smart cameras 104A, 104B, 104C, 104D, 104E, 104F can be timestamped and stored in short chunks of, for example, one second, 2 seconds, or 5 seconds, so that short snippets of video content (e.g., of length between 4 seconds and 60 seconds) can be easily created by concatenating temporally consecutive chunks of the stored video content. The recorded video content can include video of one or more users 120 within the field of view of a smart camera 104A, 104B, 104C, 104D, 104E, 104F at a location 106A, 106B, 106C, 106D, 106E, 106F. In an example implementation in which the location 106A, 106B, 106C, 106D, 106E, 106F includes a tennis court and in which two users are playing tennis on the court, the recorded video content can include video of the users playing a tennis match.

In some implementations, a timestamp associated with video content stored locally on a smart camera 104A, 104B, 104C, 104D, 104E, 104F can be based on a time retrieved from the Internet. For example, a program running on a smart camera 104A, 104B, 104C, 104D, 104E, 104F can query a time API to retrieve a current time from a server that is connected through the Internet to the smart camera 104A, 104B, 104C, 104D, 104E, 104F. In some implementations, the query can be generated and sent when the program is loaded or initialized on the smart camera 104A, 104B, 104C, 104D, 104E, 104F. After the current time has been retrieved from the server it can serve as a reference time that can be used to determine a timestamp for video content captured at later times. For example, a smart camera 104A, 104B, 104C, 104D, 104E, 104F can include a clock that determines an elapsed time after the time at which the reference time was retrieved received from the server. Then, a timestamp associated with video content generated by the smart camera can be determined by determining the elapsed time at which the video content is generated and adding that elapsed time to the reference time. The reference time and the timestamp can be provided in a standard format, such as, for example, standards ISO8601 or RFC3339.

In some implementations, a smart camera 104A, 104B, 104C, 104D, 104E, 104F may not be connected to the Internet and therefore may not be able to retrieve a current time from the Internet. For example, if a mart camera 104A, 104B, 104C, 104D, 104E, 104F is deployed in a location that lacks reliable connectivity to the Internet, the smart camera may be incapable of querying an Internet-connected server for a current time. This may be the case in situations where a number of smart cameras 104A, 104B, 104C, 104D, 104E, 104F are deployed in a facility (e.g., a multiple-court tennis facility, a multi-field soccer complex, etc.) in which a reliable Internet connection is not universally available in all locations of the facility. In some implementations, a smart camera 104A, 104B, 104C, 104D, 104E, 104F may not be connected to the Internet to reduce power consumption by the camera while it is deployed. This may be the case in situations where a number of smart cameras 104A, 104B, 104C, 104D, 104E, 104F are deployed to capture video content over a long time period (e.g., greater than eight hours) during the course of an event (e.g., a tournament) at a facility with the expectation that the video content will be uploaded to a server after the conclusion of the long time.

When it is likely, or possible, that a smart camera 104A, 104B, 104C, 104D, 104E, 104F may not be connected to the Internet to be able to receive a current time from the Internet, the smart camera nevertheless can generate a reliable timestamp when the smart camera includes a real-time clock (RTC) module that generates a time signal that is aligned with a standard time, e.g., a universal time clock signal. The RTC module can provide a highly accurate clock that is powered by an onboard dedicated battery, so that the RTC module can continuously provide a reliable and accurate time signal to a smart camera 104A, 104B, 104C, 104D, 104E, 104F. Thus, the RTC module can continuously provide a time signal that can be used to generate a timestamp for video content captured by the smart camera, even when the smart camera is not connected to the Internet and when the smart camera is not powered on. To ensure that the time signal provided by the RTC module is aligned with a time signal provided by an Internet-connected server, in some implementations, the time tracked by the RTC module can be synchronized with the time provided by the Internet before the RTC module is sold, and then because the RTC module can accurately keep time with very little drift, the time provided by the RTC module can be used as a proxy for the time provided from an Internet-connected server.

In some implementations, when a smart camera 104A, 104B, 104C, 104D, 104E, 104F establishes a connection to the Internet, the smart camera can receive a time signal from an Internet-connected server, which can be used to resync the time signal provided by the RTC module with a universal time signal provided by the Internet-connected server. In this manner, any drift between the time signal provided by the RTC module and the Internet-connected server since the previous time that the RTC module was synchronized with the Internet-connected server time can be zeroed out. In some implementations, a smart camera 104A, 104B, 104C, 104D, 104E, 104F may store video content for only a predetermined amount of time (e.g., 5-10 days) before the content is automatically deleted from the camera. If more than the predetermined amount of time elapses after the video content is first stored on the smart camera, without the smart camera connecting to the Internet to upload the content, the content may be deleted from the smart camera and permanently lost. Thus, it is expected that a smart camera 104A, 104B, 104C, 104D, 104E, 104F will connect to the Internet at least within a few days of capturing video content and that when the camera does connect to the Internet, that a time signal will be retrieved from an Internet-connected server to resync the RTC module with the Internet-based time signal.

Thus, when a smart camera 104A, 104B, 104C, 104D, 104E, 104F includes an RTC module but is not connected to the Internet, or is only intermittently connected to the Internet, the RTC module can provide a time signal with which to generate a timestamp for the video content captured by the smart camera, where the timestamp provided by the RTC module can be used to locate a particular snippet of video content in response to a command that queries the smart camera for the snippet based on a timestamp included in the command.

In some implementations, the cameras 104A, 104B, 104C, 104D, 104E, 104F can be connected to a router connected to a modem 112 that links the cameras over a network 114, for example, the Internet, to a cloud-based control server 116 that is configured to control functionality of individual cameras and to a cloud-based storage server 118 that is configured to store video content received from the cameras 104A, 104B, 104C, 104D, 104E, 104F and to provide the received video content to users of the system 100. In some implementations, the cloud-based control server 116 and the cloud-based storage server 118 can be part of a unified system, and in some implementations the control server 116 and the storage server 118 can be separate and distinct systems. As described above, in some implementations, the cameras 104A, 104B, 104C, 104D, 104E, 104F can be continuously connected to the Internet and in other implementations, the cameras 104A, 104B, 104C, 104D, 104E, 104F can be generally unconnected to the Internet when deployed but can be temporarily connected to the Internet to upload their video content to an Internet-connected server. In still other implementations, the cameras 104A, 104B, 104C, 104D, 104E, 104F can be unconnected to the Internet when deployed and can have their video content extracted from a storage device (e.g., a memory) within the camera and then the video content can be transmitted to an Internet-connected server.

The cloud-based control server 116 can include, for example, an application server that sends and receives data to the cameras 104A, 104B, 104C, 104D, 104E, 104F to control the functionality of the cameras. For example, the cloud-based control server 116 can instruct an individual camera 104A, 104B, 104C, 104D, 104E, 104F associated with a particular location 106A, 106B, 106C, 106D, 106E, 106F to begin and end recording video content in the field of view of the camera, to change (e.g., to zoom, focus, pan, etc.) the field of view of the camera, and to concatenate stored chunks of stored video content to form snippets and to upload particular snippets of video content to the cloud-based storage server.

The facility 102 can include one or more unique identifiers 108A, 108B, 108C, 108D, 108E, 108F, each unique identifier being associated with a respective particular location 106A, 106B, 106C, 106D, 106E, 106F of the facility. In some implementations, the unique identifier 108A, 108B, 108C, 108D, 108E, 108F for a particular location can include a plurality of alphanumerical characters (e.g., “1234”, “Court15”, “1$K9”). In some implementations, the unique identifier 108A, 108B, 108C, 108D, 108E, 108F for a particular location can include a computer readable code, such as, a barcode, or a QR code, which may be provided on a fixed sign or placard associated with (e.g., proximate to) a particular location 106A, 106B, 106C, 106D, 106E, 106F, or that may be provided on a programmable display (e.g., the display of a tablet computing device or of a kiosk). A user of the system 100 can enter a unique identifier 108A, 108B, 108C, 108D, 108E, 108F associated with a particular location 106A, 106B, 106C, 106D, 106E, 106F into a mobile computing device (e.g., a mobile computing device or a wearable device) to gain control of the ability to request the generation of video snippets from a camera 104A, 104B, 104C, 104D, 104E, 104F associated with the particular location 106A, 106B, 106C, 106D, 106E, 106F, such that the video snippets are uploaded from the camera 104A, 104B, 104C, 104D, 104E, 104F to the cloud-based storage server 118 for retrieval, viewing, and sharing by the user.

In some implementations, entering the unique identifier 108A, 108B, 108C, 108D, 108E, 108F can provide a user with control of the ability to request video snippets from a camera associated with the particular location 106A, 106B, 106C, 106D, 106E, 106F for a limited amount of time. For example, when a location 106A, 106B, 106C, 106D, 106E, 106F includes a tennis court at the facility and a user is scheduled to play on the court during a particular time interval, entering the unique identifier 108A, 108B, 108C, 108D, 108E, 108F for the location 106A, 106B, 106C, 106D, 106E, 106F may provide the user with the ability to request video content recorded only during the time interval.

In some implementations, the unique identifier 108A, 108B, 108C, 108D, 108E, 108F can be a dynamic identifier that is changed periodically. For example, in the case in which the location is a tennis court at a facility, the unique identifier 108A, 108B, 108C, 108D, 108E, 108F can be different for each particular time interval for which different users make use of the tennis court. For example, the unique identifier 108A, 108B, 108C, 108D, 108E, 108F can have a first value for a first time interval in which a first group of players make use of the court and can have a second value for a second time interval in which a second group of players make use of the court, and the first value can be provided only to the first group and the second value can be provided only to the second group. In some implementations, the unique identifier for a location and a time interval can be changed more than once per ten minutes, more than once per three minutes, or more than once per minute.

In some implementations, the facility 102 can include a reception or host site 110 that includes a kiosk, tablet, or programmable display that can provide unique identifiers 108A, 108B, 108C, 108D, 108E, 108F associated with different locations 106A, 106B, 106C, 106D, 106E, 106F of the facility. Then, when a user checks in at the facility before using a particular location 106A, 106B, 106C, 106D, 106E, 106F (e.g., a tennis court reserved for a particular time interval), the user can receive the particular unique identifier 108A, 108B, 108C, 108D, 108E, 108F associated with the location and the time interval from the site 110 to allow the user to request snippets of video content captured by the camera(s) associated with the location during the particular time interval. In some implementations, the user can receive the unique identifier 108A, 108B, 108C, 108D, 108E, 108F for the location and the time interval by scanning a QR code with the user's mobile computing device 122 or by entering a code on the user's wearable device 124 that is linked to the user's mobile computing device. Entering the code can enable a web service or a web app running on the user's mobile computing device or on the user's wearable device to request snippets of video content captured by the camera(s) associated with the location during the particular time interval.

During the time interval for which a particular user 120A has been authorized, by entering a unique identifier 108A for a particular location 106A, to request snippets of video content from one or more cameras 104A associated with the particular location 106A, the user 120A can cause the system 100 to generate video snippets from video content captured and stored locally on the camera(s) by interacting with the user's mobile computing device 122A or with the user's wearable computing device 124A. For example, the user 120A can enter a command into their mobile computing device 122A or their wearable computing device 124A, for example, by executing a tap gesture on a user interface icon displayed on the device 122A or 124A to cause the generation of a video snippet and the uploading of the video snippet to the cloud-based storage server 118. The entry of such a command can be tagged with a timestamp, where the timestamp can be generated by the mobile computing device 122A, and where the timestamp generated by the mobile computing device can be based on a time signal provided by an Internet-connected server that is connected to the mobile computing device. The timestamped-command can be sent to the cloud-based control server 116 (either through a wireless local area network (WLAN) that is connected to the Internet, e.g., by way of a router connected to a modem 112, or over a cellular connection to a cellular network 126 that connects to the Internet), which then instructs the one or more cameras 104A associated with the particular location 106A to generate the snippet based on the command and the timestamp. In some implementations, when the server 116 is connected to the one or more cameras 104A, the server 116 can provide instructions contemporaneous with the receipt of the command to the one or more cameras 104A to generate the snippet based on the command and the timestamp. In some implementations, when the server 116 is not connected to a camera 104A, the server 116 can store the command and then when the camera 104A is connected to the server 116, the server can provide instructions to the one or more cameras 104A to generate the snippet based on the command and the timestamp. Thus, the user can generate, and the server 116 can receive, the command to generate snippet at a first time, and the server then can store the command and provide the instructions to the camera 104A at a second time long after the first time (e.g., more than 10 minutes after the first time, more than 30 minutes after the first time, more than one hour after the first time).

In some implementations, the snippet can have a fixed time length starting before the timestamp of the command and ending at the time of the entry of the command or a predetermined amount of time before the command. In some implementations, a trained machine learning (ML) model running on the smart camera can determine a start time and an end time for the snippet based on the timestamp of the command. For example, the ML model can be trained, using labeled training data including video content related to the content that is expected to be captured, to determine the start time and the end time of a snippet based on actions of users or participants in the field of view of the camera before the time of the command. In some cases, the actions of the users can correspond to an identifiably discrete point or play in a sports game, which occurs before the time of the user's command to generate a snippet, and the smart camera running the ML model, which has been trained on video content data of playing the sports game, can generate a snippet that corresponds to the discrete point or play based on the timestamp of the command.

Once the snippet is generated by the smart camera(s) 104A, the snippet is uploaded to the could-based storage server 118. The snippet can be tagged with a timestamp and with a location stamp corresponding to the location 106A from which it was generated. Then, users who have received a unique identifier 108A corresponding to the location 106A and the time interval from which the snippet was generated can access the cloud-stored snippet from the storage server 118 to view, download, and share the snippet. A user's access to the snippet is not limited to the time interval of the unique identifier 108A but can be permanent or for a limited time (e.g., 90 days, or one year). In some implementations, the user may have signed up for an account associated with the cloud-based storage server 118, where the user may login to the account (e.g., by providing authentication credentials, such as a username and password) and where the account may permit the user to access and use video content stored in the cloud-based storage server 118 in a particular way (e.g., by editing stored snippets, sharing the stored content with others, etc.). In some implementations, the user may not need to sign up for a permanent account associated with the cloud-based storage server 118 but may be provided with a temporary account when the user receives the unique identifier, where the temporary account may permit the user to receive and/or access video content from the cloud-based storage server.

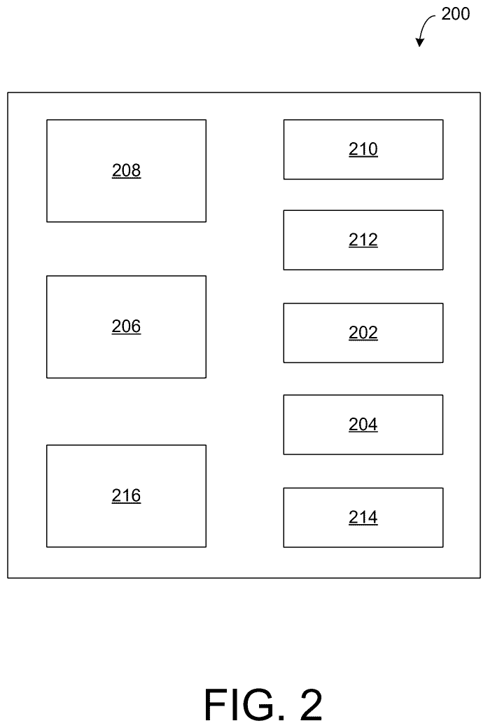

FIG. 2 is a schematic diagram of an example smart camera 200, which can be used as one of the smart cameras 104A, 104B, 104C, 104D, 104E, 104F in the system 100 shown in FIG. 1. The smart camera 200 includes optical elements 202, which can include, for example, lenses, mirrors, an aperture, and other elements for projecting an image of a field of view of the camera onto an image sensor 204. As explained above, the image sensor can include a charge coupled device (CCD) or an active pixel sensor, such as, for example, a complimentary metal-oxide semiconductor (CMOS) sensor, for capturing images of the objects (e.g., frames of video content) in the field of view of the camera 200. Video content including captured images of the objects can be stored in one or more memory devices 206 of the smart camera 200.

The one or more memory devices 206 can include, for example, random access memory (RAM) and non-volatile memory, such as, for example, flash memory. In some implementations, the non-volatile memory of the smart camera can include at least 64 gigabytes, at least 128 gigabytes, at least 256 gigabytes, or at least 512 gigabytes of storage capacity. The one or more memory devices 206 can store executable instructions that can be executed by a processor 208, for example, a central processing unit (CPU) to perform various functions of the smart camera described herein. The one or more memory devices 206 can store one or more trained machine learning models that can be executed by the processor 208 to perform various functionality of the smart camera 200, as described herein.

The smart camera 200 can include transmission and receiving circuitry 210 that can send and receive data to/from a network to which the smart camera 200 is connected.

The transmission and receiving circuitry 210 can include, for example, a Wi-Fi transceiver that communicates with other devices over a standard transmission protocol, e.g., IEEE 802.11 and/or a Bluetooth transceiver that communicates with other devices over a Bluetooth standard transmission protocol. The smart camera 200 can include one or more motors 212 that can be configured for adjusting a focal length of the optical elements 202 and for changing the direction of the field of view of the camera 200. The smart camera 200 can include a GPS transceiver 214 configured for determining a position of the camera. In some implementations, a plurality of the components of the smart camera 200 can be included on a single-board computer, such as, for example, a Raspberry Pi computer. The smart camera 200 can further include an RTC module 216 configured to provide a time signal used to generate a timestamp for video content captured by the camera 200.

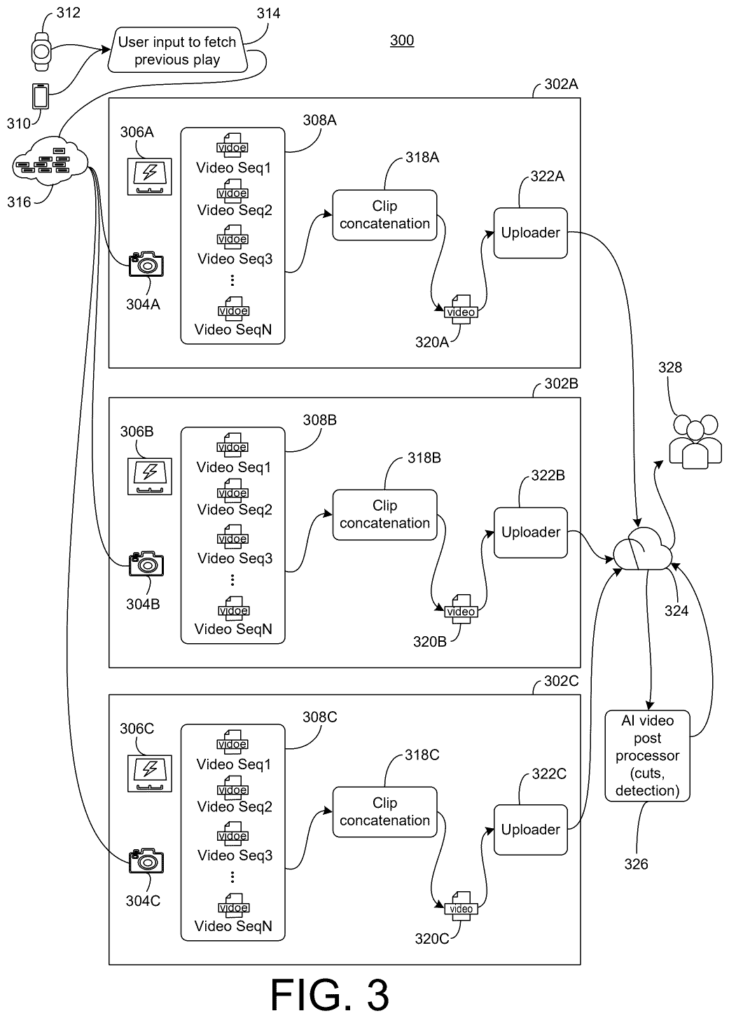

FIG. 3 is a schematic view of an example workflow of a process 300 for saving a snippet of video content from one or more smart cameras 302A, 302B, 302C to a cloud-based storage device to make the snippet available to a user. The smart cameras 302A, 302B, 302C can be associated with a location of a facility and each smart camera can capture video content of its respective point of view of the location with optics and sensors 304A, 304B, 304C. The captured video content can be stored in internal storage 306A, 306B, 306C of the smart cameras, for example, in discrete chunks of sequential short video segments 308A, 308B, 308C, each of which is timestamped with a time at which it was captured. The time timestamp can be based on a time signal provided by an RTC module 216 or on a time signal provided by a server connected to the smart camera 302A, 302B, 302C over the Internet. The discrete chunks of sequential short video segments 308A, 308B, 308C can be created using a number of different video processing tools, such as, for example, FFmpeg, Openshot, Avidemux. The timestamp associated with each chunk can correspond to the beginning time of the chunk or the end time of the chunk. In some implementations, each of the short video segments 308A, 308B, 308C can include one or more keyframes. While a smart camera is on and capturing video content, the chunks of sequential short video segments 308A, 308B, 308C can be continuously stored in the internal storage 306A, 306B, 306C. When a predetermined amount of video content has been stored in the internal storage of a smart camera, portions of video content can be deleted and overwritten as new video content is captured, beginning with the oldest video content, to make room for the most recently captured video content.

When a user wants to create a short snippet of a video content (e.g., of a most recent play of a sports event taking place at the location of the smart cameras 302A, 302B, 302C), the user, who has previously been given access to create snippets from the cameras during a time interval, can enter a command to save a snippet through a user input to a client device (e.g., a mobile computing device 310 or a wearable device 312) associated with the user. In some implementations, the user can enter the command by tapping, swiping, or otherwise interacting with a user interface on the client device. The command 314 is sent to a cloud-based control server 316, which then sends a command to the smart cameras 302A, 302B, 302C to concatenate 318A, 318B, 318C a series of the sequential short video segments 308A, 308B, 308C on the cameras to create a video file of a specified length 320A, 320B, 320C.

The specified length can be a predetermined length or can be determined based on a review of actions in the video content prior to the user's command. For example, the specified length of a video file can be 30 seconds, 45 seconds, or 60 seconds, and then the video file can be uploaded to the cloud-based storage server, where it can be trimmed based on the actions in the video file (e.g., so that the trimmed video corresponds to a single point of a sports game.

The predetermined length can be based on the activity that the smart camera captures content from. For example, the average duration of a tennis or pickleball point may be much longer than the duration of a golf shot at a driving range, and therefore the predetermined length of a video file generated by a smart camera at a tennis or pickleball location may be longer than the predetermined length of a video file generated by a smart camera at a driving range tee. Of course, the durations of a number of relevant events captured by a smart camera at a location (e.g., a tennis or pickleball point, a golf shot, a performance of a musical passage, etc.) may vary over a range of times and the distribution of durations can be characterized by a standard deviation. In some implementations, the predetermined length selected for a video file generated by smart camera at a location can be selected to correspond to events that deviate from an average duration of an event by up to one, up to two, up to three, or up to four, standard deviations, to ensure that the full duration of nearly all events is captured in the generated video file. In some implementations, a processor of the smart camera can execute code to determine a duration for an individual video file. For example, the processor may execute code to analyze video content stored for on the camera from a period of time before the user entered the command to save a snippet to determine relevant beginning and ending time for the snippet.
For example, the code can be executed to determine a beginning and an end of a point of a tennis match, and to generate the snippet for a time duration that includes the beginning and end of the point.

After the video files 320A, 320B, 320C are created, they are uploaded by strategic uploaders 322A, 322B, 322C running on the smart cameras to a cloud-based storage server 324. Uploading by strategic uploaders 322A, 322B, 322C can be coordinated by the cloud-based control server 316 to provide for efficient transfer of the video content data over a network to the cloud-based storage server. For example, the cloud-based control server 316 can instruct a first camera 302A to upload its video file 320A, and then after the uploading of the video file 320A has been completed, the cloud-based control server can instruct a next smart camera 302B to upload its video file 320B, and so on. In this manner, competition for network resources between the different smart cameras 302A, 302B, 302C can be reduced to provide for an efficient transfer of the video files 320A, 320B, 320C from the cameras 302A, 302B, 302C to the cloud-based storage server 324.

Within the cloud-based storage server 324 the uploaded video files can be edited by one or more video processing tools 326. For example, the tools can be used to detect particular actions in the video files that should be included in, or omitted from, content provided to users from the cloud-based storage server 324, can measure brightness, color, blur, etc. in the video files and can edit the files accordingly. The video files in the cloud-based storage server 324 then can be made available for downloading, viewing, sharing, etc. by users 328.

In an implementation, the tools executed by the cloud-based storage server 324 can include one or more machine learning models that can be used to create a synthetic video file from the content of the multiple video files from the different smart cameras associated with a location. For example, if a tennis court location includes cameras with points of view from each baseline, from the net, and from overhead, a machine learning tool can be used to create a synthetic video file from the video files of the different points of view, in which the synthetic video file cuts between the different points of view to provide a compelling user viewing experience of the action taking place at the location. The machine learning model can be trained, for example, on video data captured from multiple cameras where a video technician selects between the video from the different cameras to broadcast to a viewing audience.

In some implementations, when a plurality of smart cameras is associated with a location, a synthetic video file can be created from the content captured from different individual smart cameras by stitching content from different cameras together. In some implementations, the content from the different cameras for generating the synthetic video file can be selected locally at the location of the smart cameras, for example, by one or more of the smart cameras, so that large amounts of content from all of the different smart cameras need not be uploaded to the cloud-based storage server 324 for processing to generate the synthetic video file.

For example, if four smart cameras are associated with a location, one of the cameras can serve as a primary camera (e.g., a camera that provides a wide point of view of a tennis court) and the other cameras can serve as secondary cameras (e.g., cameras that provide a closeup point of view of each player on the tennis court, that provide a closeup point of view of action near the net of the tennis court, etc.). Each of the cameras can capture video content from its respective point of view, but, in some implementations, the content from only one camera may be uploaded to the cloud-based storage server 324 at any given time.

A trained machine learning model running on the primary smart camera can process video content captured by the primary camera and determine, based on action in the video content, when content from a point of view provided by one of the secondary cameras would be more compelling to a viewer than content from the primary camera. In such cases, instead of uploading video content from the primary camera, the content from the secondary camera instead can be uploaded to the cloud-based storage server 324 for a period of time. When the machine learning model running on the primary smart camera determines that the content from the point of view provided by the secondary cameras would be less compelling to a viewer than content from the primary camera, the video content from the primary camera can again be uploaded to the cloud-based storage server 324.

In this manner, a synthetic video file can be generated at the cloud-based storage server 324 from the video content that is provided from the different smart cameras by cutting back and forth between uploading content from different smart cameras to the cloud-based storage server 324. This can be done without having to upload all the content from all the local camera, thus saving bandwidth and reducing the amount of data that must be stored and processed at the cloud-based storage server 324.

In some implementations, when the synthetic video file is generated for a live streaming situation, the uploading of video content can be delayed for a period of time period of time (e.g., 10 seconds) to allow the primary smart camera to process its incoming video content to determine whether to upload video content from a secondary camera instead of from the primary camera. In some implementations, for a live streaming of the video content, the primary smart camera can process its incoming video content, and when it determines that uploading video content from a secondary camera would be more compelling that content from the primary camera, the content from the secondary camera can be uploaded for insertion into the synthetic video file as a replay or highlight. For example, when the smart cameras are associated with a tennis court, for an exciting point that ended with both players at the net, the primary smart camera may determine that video content from the end of the point provided by a secondary camera having a closeup point of view of action at the net would be more compelling than content from the primary camera of the players walking back to their respective positions to begin the next point. Accordingly, the primary camera could cease uploading video content during the time when the players are walking back to their respective positions, and, instead, content from the secondary camera captured during the end of the exciting point can be uploaded, where the content from the secondary camera captured during the end of the exciting point was captured before, and as an earlier timestamp, then video content from the primary camera of the players walking back to their respective positions. In this manner, a “replay” of a portion of the point can be inserted into the synthetic video file.

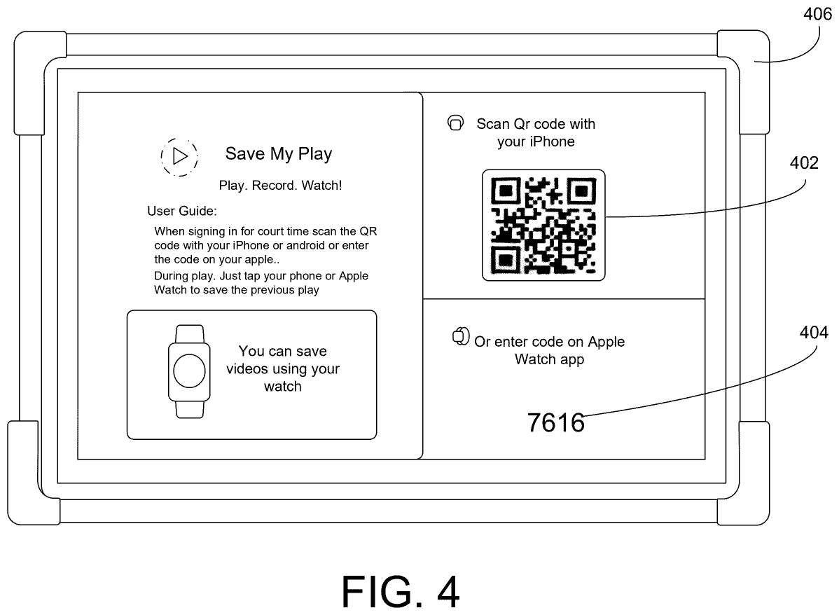

FIG. 4 is an example perspective view of unique identifiers 402, 404 that can be used by a user to acquire access to the ability to save and access video content from the smart cameras, where video content is recorded from a particular location and during a particular time interval. In a first example of a unique identifier 402, the unique identifier can include a computer readable image, for example, a QR code, that is associated with the particular location and the particular time interval. In a second example of the unique identifier 404, the unique identifier can include an alphanumeric character string that is associated with the particular location and the particular time. The unique identifier can be displayed on a display of a computing device, for example, a tablet computer 406. Scanning the QR code 402 with a mobile computing device can launch a web service on the mobile computing device through which a user can send commands to a cloud-based control server to initiate the generation of video snippets from chunks of video captured by a camera and through which the user can access the generated video snippets from hey cloud-based storage server. Similarly, entering the code 404 on a wearable computing device (e.g., a smartwatch) can launch a web app on the wearable computing device or on a mobile computing device connected to the wearable computing device. The user can send commands through interactions with the wearable computing device to the cloud-based control server to initiate the generation of video snippets from chunks of video captured by a camera, and then the user can access the generated video snippets from the cloud-based storage server.

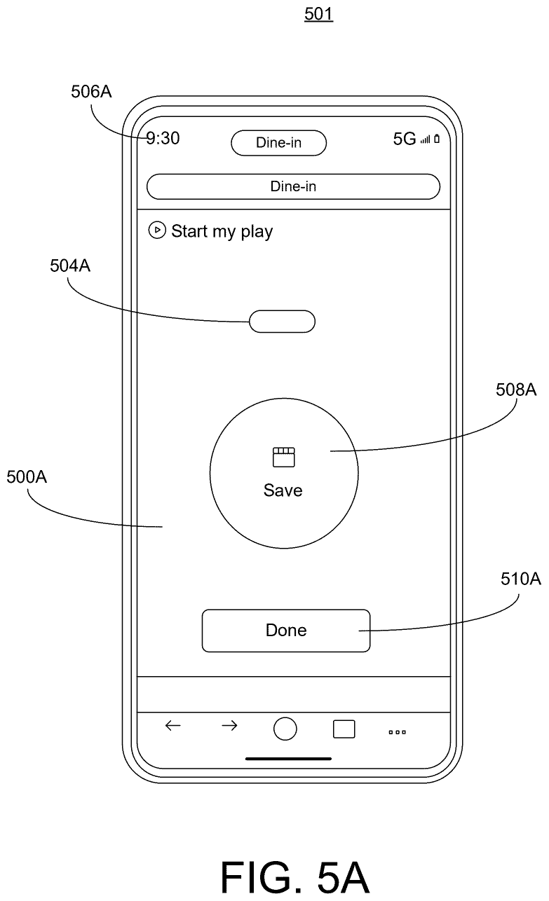

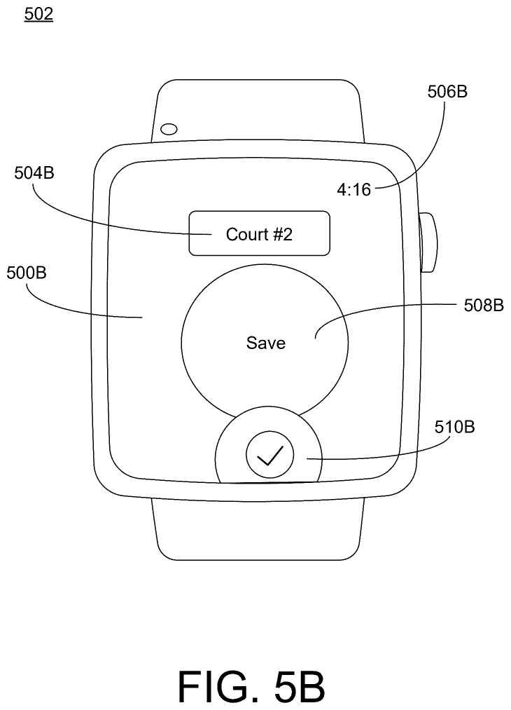

FIG. 5A is a screenshot of an example user interface 500A executing on a mobile computing device 501. FIG. 5B is a screenshot of an example user interface 500B executing on a wearable computing device 502, through which a user can send commands to a cloud-based control server to cause a smart camera to generate a video snippet from video content stored on the smart camera and to upload the generated video snippet to a cloud-based storage server.

The user interface 500A, 500B can include an icon 504A, 504B identifying a particular location with which the camera is associated and an icon 506A, 506B representing a current time.
In addition, the user interface 500A, 500B can include a user interface element 508A, 508B that the user can select to initiate the generation and uploading of the video snippet, which can be timestamped with a time related to the time at which the user selected the user interface element 508A, 508B. For example, tapping on the user interface element 508A, 508B can cause the smart camera to generate the video snippet and to upload it to the cloud-based storage server. The user interface element 508A, 508B can be selected multiple times to generate multiple different video snippets. When the user has finished generating video snippets from the stored video content, the user can tap another user interface element 510A, 510B to indicate that the user has finished generating video snippets from content associated with the particular location and the particular time interval and to launch a different user interface through which the user can review the generated video snippets.

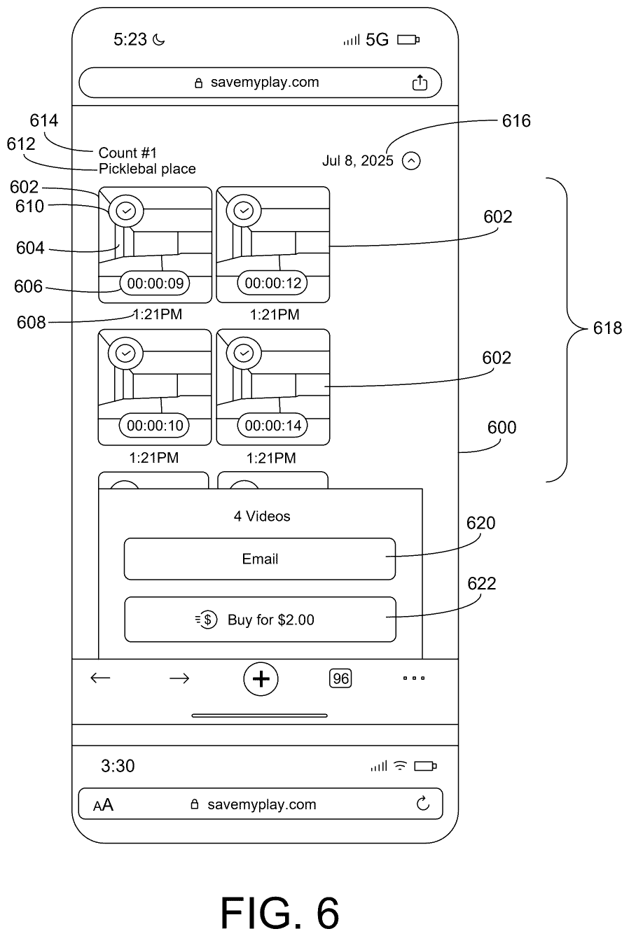

FIG. 6 is a screenshot of an example user interface 600 of a web service executing on a mobile computing device. In the user interface 600, a user can preview and select generated video snippets 602 for purchase and additional access. After a user has caused the generation of a number of video snippets from a camera associated with a particular location of a facility during a particular time interval, the user interface 600 can provide previews of the generated snippets. The name 612 of the facility and the location 614 within the facility can be indicated in the user interface 600. In addition, the date 616 of the particular time interval can be indicated in the user interface 600.

In some implementations, the preview 602 of a snippet can include a screenshot 604 of the snippet, a time duration 606 of the snippet, a timestamp 608 of the snippet, and a selectable user interface element 610 that the user can select to indicate an intent to purchase access to the snippet. Previews 602 of snippets can be displayed in a scrolling portion 618 of the user interface 600, so that the user can input a gesture (e.g., a swipe gesture) to a touchscreen displaying the scrolling portion of the user interface 600 preview additional snippets. The user interface 600 can include an input field 620 in which the user can enter an email address to which additional access to snippets can be provided. After entering an email address, the user can select a user interface element 622 to purchase the additional access to the selected video snippets. After selecting the user interface element 622, the user can enter payment information to purchase the additional access. Once payment has been made, the cloud-based control server can provide access to the selected snippets in the cloud-based storage server to the user, for example, by sending the selected snippets to the user at the user's email address or by sending a link, or a plurality of links to the snippets to the user's email address, where the user can open the link(s) to gain access to the video snippets.

The user need not create an account with the provider of the web service to access the functionality of the web service shown in FIG. 6. Usage of the web service with a permanent account can cause a browser-based token-secured “temp” account to be created on behalf of the user, where the temp account is associated with the email address provided in input field 620. Then, any videos the user saves, selects, or purchases in the web service can be accessed again by returning to the web service, so long as a cookie associated with the web service is not cleared from local storage of the local computing device running the web service.

In some implementations, the transmission and receiving circuitry 210 of a smart camera 200, which communicates with other devices over a standard transmission protocol, e.g., IEEE 802.11 can be leveraged during the setup process of the smart camera to efficiently locate and configure the smart camera for use in a facility. For example, a technician can place a smart camera 200 in a test location within the facility and can connect a computing device controlled by the technician to the Wi-Fi network of the smart camera 200, so that video content captured by the smart camera can be directly transmitted to the technician's computing device for rendering in a webpage, mobile app desktop app, etc. running on the technician's computing device. In some implementations, the establishment of such a connection between the technician's computing device and the camera 200 can be based on the functionality of the WebRTC protocol to efficiently stream video content from the smart camera 200 directly to a web browser running on the technician's computing device, and can allow the transmission of the video content directly from the smart camera to the technician's computing device without using any outside bandwidth, in other words without transmitting the video content from the smart camera to a server and then from the server to the technician's computing device. With the smart camera 200 connected to the technician's computing device, settings of the camera (e.g., its location in space, the direction in which it is pointed, its focal length, its brightness and contrast, its color temperature, its frame rate and resolution, etc.) can be adjusted, and the effect of the settings can be monitored on the technician's computing device, until the technician is satisfied with the settings of the camera. Once the settings are satisfactory, the camera 200 can be disconnected from the technician's computing device in place to load in which it can capture video content from its field of view and uploaded snippets of content to a server based on commands to generate and transmit the snippets.

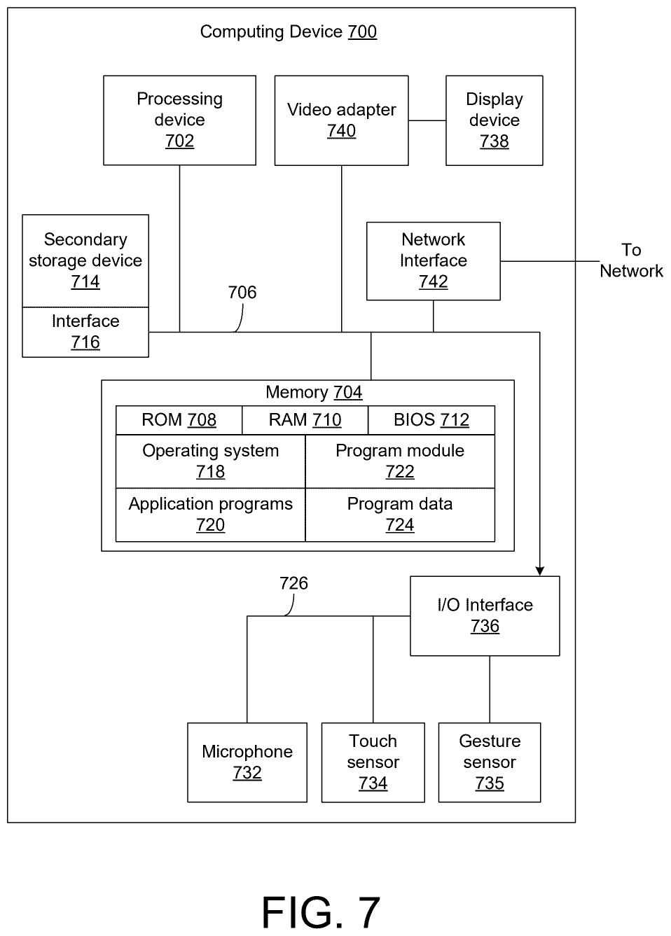

FIG. 7 illustrates an example architecture of a computing device 700 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 7 can be used to execute the operating system, application programs, firmware modules, and/or software modules described herein.

The computing device 700 includes, in some embodiments, at least one processing device 702 (e.g., a processor), such as a central processing unit (CPU). In this example, the computing device 700 also includes a system memory 704, and a system bus 706 that couples various system components including the system memory 704 to the processing device 702.

The system bus 706 is one of any number of types of bus structures that can be used, including, but not limited to, a memory bus, or memory controller; and a local bus using any of a variety of bus architectures.

The system memory 704 includes read only memory 708 and random access memory 710. A basic input/output system 712 containing the basic routines that act to transfer information within computing device 700, such as during start up, can be stored in the read only memory 708.

The computing device 700 also includes a secondary storage device 714 in some embodiments, such as a flash drive, for storing digital data. The secondary storage device 714 is connected to the system bus 706 by a secondary storage interface 716. The secondary storage device 714 and its associated computer readable media provide non-volatile and non-transitory storage of computer readable instructions (including application programs and program modules), data structures, and other data for the computing device 700.

Although the example environment described herein employs a flash drive as a secondary storage device, other types of computer readable storage media are used in other embodiments. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 714 and/or system memory 704, including an operating system 718, one or more application programs 720, other program modules 722 (such as the software engines described herein), and program data 724. The computing device 700 can utilize any suitable operating system, such as Microsoft Windows™, Google Chrome™ OS, Android, or Linux and variants and any other operating system suitable for a computing device.

In some embodiments, a user provides inputs to the computing device 700 through one or more input devices 726. Examples of input devices 726 include a microphone 732 (e.g., for voice and/or other audio input), a touch sensor 734 (such as a touchscreen or touch sensitive display), and gesture sensor 735 (e.g., for gestural input). Other embodiments include other input devices 726. The input devices can be connected to the processing device 702 through an input/output interface 736 that is coupled to the system bus 706. These input devices 726 can be connected by any number of input/output interfaces, such as a parallel port, serial port, game port, or a universal serial bus.

In this example embodiment, a display device 738, such as a liquid crystal display device, light-emitting diode display device, or touch sensitive display device, is also connected to the system bus 706 via an interface, such as a video adapter 740.

The computing device 700 can be connected to one or more networks through a network interface 742. The network interface 742 can provide for wired and/or wireless communication. In some implementations, the network interface 742 can include one or more antennas for transmitting and/or receiving wireless signals. When used in a local area networking environment or a wide area networking environment (such as the Internet), the network interface 742 can include an Ethernet interface. Other possible embodiments use other communication devices. For example, some embodiments of the computing device 700 include a modem for communicating across the network. Wireless communication between the computing device 700 and other network-connected devices can occur over BLUETOOTH® wireless technology, 802.11a/b/g/n, cellular, ultra-wideband (UWB), ZigBee, or other radio frequency communication systems in some possible embodiments, to name just a few examples.

The computing device 700 can include at least some form of computer readable media. Computer readable media includes any available media that can be accessed by the computing device 700. By way of example, computer readable media include computer readable storage media and computer readable communication media.

Computer readable storage media includes volatile and non-volatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, or any other medium that can be used to store the desired information and that can be accessed by the computing device 700.

Computer readable communication media typically embodies computer readable instructions, data structures, program modules or other data in a modulated data signal such as a carrier wave or other transport mechanism and includes any information delivery media.

The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 7 is also an example of programmable electronics, which may include one or more such computing devices, and when multiple computing devices are included, such computing devices can be coupled together with a suitable data communication network so as to collectively perform the various functions, methods, or operations disclosed herein.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations.

It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A system for providing video files of a participant participating in an activity at a facility that includes a plurality of locations, the system comprising:
a plurality of smart cameras, wherein at least one smart camera is associated with each location of the plurality of locations, wherein each smart camera includes: an image sensor configured for capturing images of objects in a field of view of the smart camera, one or more optical elements configured for projecting an image of a field of view of the smart camera onto the image sensor, first memory configured for storing machine readable instructions, a processor configured for executing the stored instructions, second memory configured for storing video content captured by the smart camera, and transmission and receiving circuity configured to send and receive data to/from a network to which the smart camera is connected;
a cloud-based storage server configured for receiving and storing video content from each of the plurality of smart cameras; and
a cloud-based control server configured for receiving a command from a user to generate a video file of a participant participating in an activity at one of the locations of the plurality of locations at the facility, and, causing, in response to the command, at least one of the smart cameras associated with the location to generate a video file from video content captured by the camera and stored in the second memory and to send the generated video file to the cloud-based storage server.

2. The system of claim 1, wherein the processor of each smart camera is configured for causing video content captured by the smart camera to be stored in the second memory of the smart camera in distinct chunks that have a duration of less than 10 seconds and wherein the processor of each smart camera is configured to, in response to a command from the user to generate a video file, generate a video file by concatenating two or more distinct chunks of stored video content.

3. The system of claim 1, wherein each smart camera is configured to send generated video file to the cloud-based storage server without the generated video file passing though a local hub or server.

4. The system of claim 1, wherein the cloud-based storage server is configured for providing;-access to the generated video file to a user, in response to the user receiving a unique identifier from the cloud-based control server.

5. The system of claim 1, wherein the generated video file has an end time determined, at least in part, by a time at which the command is received.

6. The system of claim 1, wherein the generated video file has a predetermined time duration.

7. The system of claim 6, wherein the cloud-based storage server is configured for trimming the video file sent by the smart camera to remove portions of the video content from the video file.

8. The system of claim 1,
wherein multiple smart cameras are associated with a location of the plurality of locations,
wherein a processor of a primary smart camera of the multiple smart cameras is configured to process video content captured by the primary smart camera to determine when to send video content captured by the primary smart camera to the cloud-based storage server and when to send video content captured by a secondary smart camera of the multiple smart cameras to the cloud-based storage server.

9. The system of claim 1, wherein causing, in response to the command, at least one of the smart cameras associated with the location to generate a video file from video content captured by the camera and stored in the second memory includes:
storing the command at the cloud-based control server;
sending instructions to the at least one of the smart cameras to generate the video file, wherein the sending occurs more than 30 minutes after the command is received from the user.

10. A method of providing video files of a participant participating in an activity at a facility that includes a plurality of locations, the method comprising:
capturing video content with at least one smart camera associated with a location of the plurality of locations, wherein the at least one smart camera includes: an image sensor configured for capturing images of objects in a field of view of the smart camera, one or more optical elements configured for projecting an image of a field of view of the smart camera onto the image sensor, first memory configured for storing machine readable instructions, a processor configured for executing the stored instructions, second memory configured for storing video content captured by the smart camera;
storing video content captured by the smart camera in the second memory;
receiving, at a cloud-based control server, a command from a user to generate a video file of a participant participating in an activity at the location of the plurality of locations;
providing instructions from the cloud-based control server to the at least one smart camera for the smart camera to generate a video file from the stored video content captured by the camera and stored in the second memory; and
transmitting the generated video file from the smart camera to a cloud-based storage server for storage the cloud-based storage server.

11. The method of claim 10, wherein storing the video content in the second memory includes storing the video content in distinct chunks that have a duration of less than 10 seconds and wherein generating the video file includes concatenating two or more distinct chunks of stored video content.

12. The method of claim 10, wherein transmitting the generated video file to the cloud-based storage server includes transmitting the generated video file without the generated video file passing though a local hub or server.

13. The method of claim 10, further comprising:
providing access to the generated video file to a user, in response to the user receiving a unique identifier from the cloud-based control server.

14. The method of claim 10, wherein the generated video file has an end time determined, at least in part, by a time at which the command is received.

15. The method of claim 10, wherein the generated video file has a predetermined time duration.

16. The method of claim 15, trimming, by the cloud-based storage server, the video file sent by the smart camera to remove portions of the video content from the video file.

17. The method of claim 10,
wherein multiple smart cameras are associated with a location of the plurality of locations,
wherein a processor of a primary smart camera of the multiple smart cameras is configured to process video content captured by the primary smart camera to determine when to send video content captured by the primary smart camera to the cloud-based storage server and when to send video content captured by a secondary smart camera of the multiple smart cameras to the cloud-based storage server.

18. The method of claim 10, wherein causing, in response to the command, at least one of the smart cameras associated with the location to generate a video file from video content captured by the camera and stored in the second memory includes:
storing the command at the cloud-based control server;
sending instructions to the at least one of the smart cameras to generate the video file, wherein the sending occurs more than 30 minutes after the command is received from the user.
